(19) United States
(12) Patent Application Publication
(10) Pub. No.: US 2007/0249406 A1
(43) Pub. Date: Oct. 25, 2007

(54) METHOD AND SYSTEM FOR RETRIEVING INFORMATION

(75) Inventor: Markus Mans Folke Andreasson, Lund (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Sony Ericsson Mobile Communications AB, Lund (SE)

(21) Appl. No.: 11/379,385

(22) Filed: Apr. 20, 2006

(51) Int. Cl. H04B 1/38; H04M 1/00

(52) U.S. Cl. 455/563

(57) ABSTRACT

System and method for receiving information in a communication terminal during a voice conversation session with a remote communication terminal. After initiating the voice conversation between a first and a second communication terminal, audio signals of the voice conversation are passed to a speech recognition engine to identify a keyword from the voice conversation. The identified keywords are then used for locating and retrieving information related to the keyword, and the retrieved information is presented on the display of at least one of the first and second communication terminals.

### FIELD OF THE INVENTION

The present invention relates to methods and systems for retrieving information, and in particular the retrieval of information during a voice conversation carried out between two communication terminals.

### BACKGROUND

The cellular telephone industry has had an enormous development in the world in the past decades. From the initial analog systems, such as those defined by the standards AMPS (Advanced Mobile Phone System) and NMT (Nordic Mobile Telephone), the development has during recent years been almost exclusively focused on standards for digital solutions for cellular radio network systems, such as D-AMPS (e.g., as specified in EIA/TIA-IS-54-B and IS-136) and GSM (Global System for Mobile Communications). Currently, the cellular technology is entering the so called 3^{rd} generation (3G) by means of communication systems such as WCDMA, providing several advantages over the former 2^{nd} generation digital systems referred to above.

The traditional way of communication between two or more remote parties is voice conversation, where speech signals are communicated by means of radio signals or electrical wire-bound signals. Normally, such communication occurs over an intermediate communications network, such as a PSTN or cellular radio network. An alternative solution is to transmit signals directly between the communication terminals, such as between walkie-talkie terminals. Today, mobile telephony communication increases rapidly, and is already the dominating means for speech communication in many areas of the world. Mobile phones also become increasingly sophisticated and many of the advances made in mobile phone technology are related to functional features, such as better displays, more efficient and longer lasting batteries, built-in cameras and so on. Increased memory space and computational power, together with graphical user interfaces including large size touch-sensitive displays have led to the mobile phone being capable of handling more and more information, such that the limit between what can be called a mobile phone and what can be called a pocket computer is fading away. However, even though text and image messaging has increased tremendously, voice conversation will most likely always have an important role in remote communications. On the other hand, voice conversation also has its disadvantages, and many users find mere speech communication to be too limited. Video telephony is an alternative, but that technology generally occupies a lot more bandwidth and requires the involvement of cameras.

### SUMMARY OF THE INVENTION

A general object of the invention is therefore to provide a system and a method for communication using communication terminals, such as telephones, where voice communication can be combined with other features to provide a higher value to traditional voice communication.

According to a first aspect of the invention, this object is fulfilled by means of a method for receiving information in a communication terminal, comprising the steps of:

initiating a voice conversation between a first communication terminal and a second communication terminal;

passing an audio signal of the voice conversation to a speech recognition engine to identify a keyword from the voice conversation;

retrieving information related to the keyword;

presenting the retrieved information in at least one of the first and second communication terminals.

In one embodiment, the voice conversation is carried out over a communications network.

In one embodiment, the speech recognition engine is located in a network server of the communications network.

In one embodiment, audio signal sent from the first communication terminal to the second communication terminal, or vice versa, is passed through the speech recognition engine.

In one embodiment, the method comprises the steps of:

entering a command in at least one of the first and second communication terminals to approve retrieval and/or presentation of information, thereby

controlling communication signals of the voice conversation to be guided through a network server including the speech recognition engine.

In one embodiment, the step of entering a command to approve retrieval and/or presentation of information is carried out prior to initiating the voice conversation, as a default setting.

In one embodiment, the step of entering a command to approve presentation of information is carried out during the step of initiating the voice conversation.

In one embodiment, the method comprises the steps of:

entering a command in at least one of the first and second communication terminals during the voice conversation to initiate passing of the audio signal to the speech recognition engine.

In one embodiment, the method comprises the steps of:

entering a command in at least one of the first and second communication terminals during the voice conversation to record an audio signal of the voice conversation in a data memory;

entering a command to terminate recording of the audio signal;

passing the recorded audio signal to the speech recognition engine.

In one embodiment, the speech recognition engine is located in one of the first and second communications terminals.

In one embodiment, the data memory is located in one of the first and second communications terminals.

In one embodiment, the step of retrieving information related to the keyword comprises the step of:

entering the keyword in an information search engine.

In one embodiment, the step of retrieving information related to the keyword comprises the step of:

searching the Internet for information related to the entered keyword.

In one embodiment, the step of retrieving information related to the keyword comprises the step of:

matching the keyword with predetermined keywords related to advertisement information stored in a memory, to retrieve an advertisement related to the identified keyword.

In one embodiment, the step of presenting the retrieved information is carried out during the initiated voice conversation.

In one embodiment, the step of presenting the retrieved information involves the step of

presenting an image on a display of at least one of the first or the second communication terminal.

In one embodiment, the step of presenting the retrieved information involves the step of

presenting, on a display of at least one of the first or the second communication terminal, a link to an information source containing more data related to the keyword.

In one embodiment, the step of presenting the retrieved information involves the step of

sounding an audible message by means of a speaker in at least one of the first or the second communication terminal.

In one embodiment, the communication terminals are mobile phones, exchanging audio signals of the voice conversation over a radio communications network.

According to a second aspect of the invention, the stated object is fulfilled by means of a system for receiving information, comprising:

a first communication terminal and a second communication terminal, which are configured to exchange audio signals in a voice conversation;

a speech recognition engine connected to receive an audio signal of a voice conversation carried out between the first and second communication terminals, and to identify a keyword in the audio signal;

an information retrieving unit configured retrieve information related to an identified keyword;

a user interface configured to present retrieved information in at least one of the first and second communication terminals.

In one embodiment, the system comprises:

a communications network for communicating audio signals between the first and second communication terminals during a voice conversation.

In one embodiment, the speech recognition engine is located in a network server of the communications network.

In one embodiment, an audio signal sent from the first communication terminal to the second communication terminal, or vice versa, is passed through the speech recognition engine.

In one embodiment, at least one of the first and second communication terminals comprises

a user interface for entering a command to approve retrieval and/or presentation of information;

a control unit configured to control audio signals of the voice conversation to be guided through a network server including the speech recognition engine, responsive to entering an approval command.

In one embodiment, the user interface of at least one of the communication terminals comprises

a call initiation function, which can be selectively activated to initiate a voice conversation communication with or without approval to retrieval and/or presentation of information.

In one embodiment, a user interface of at least one of the communication terminals comprises

a speech recognition initiation function, which can be selectively activated during a voice conversation to initiate passing of an audio signal to the speech recognition engine.

In one embodiment, the system comprises:

a data memory, and

an audio recorder, wherein the user interface of at least one of the communication terminals is operable for entering

a first command for selectively initiate recording of an audio signal of a voice conversation in the data memory;

a second command for selectively terminating recording of the audio signal, and wherein the speech recognition engine is connected to the data memory for performing speech recognition on the recorded audio signal.

In one embodiment, the speech recognition engine is located in one of the first and second communications terminals.

In one embodiment, the data memory is located in one of the first and second communications terminals.

In one embodiment, the information retrieving unit comprises an information search engine.

In one embodiment, the information retrieving unit is communicatively connectable to the Internet for retrieving information related to an entered keyword.

In one embodiment, the information retrieving unit is configured to match an identified keyword with predetermined keywords related to advertisement information stored in a memory, to retrieve an advertisement related to the identified keyword.

In one embodiment, the user interface comprises a display for presenting retrieved information.

In one embodiment, the user interface comprises a speaker for presenting retrieved information.

### BRIEF DESCRIPTION OF THE DRAWINGS

The features and advantages of the present invention will be more apparent from the following description of the preferred embodiments with reference to the accompanying drawing, on which

FIG. 1 schematically illustrates a hand-held radio communication terminal in which the present invention may be employed;

FIG. 2 schematically illustrates a system for communicating between a first terminal and a second terminal over a communications network, configured in accordance with an embodiment of the invention;

FIGS. 3 and 4 schematically illustrate the use of an embodiment of a terminal configured to record and store an audio signal to be processed in accordance with the invention; and

FIGS. 5 and 6 schematically illustrate the use of a terminal for making a sponsored call, making use of an embodiment of the invention.

### DETAILED DESCRIPTION OF PREFERRED EMBODIMENTS

The present description relates to the field of voice communication using communication terminals. Such communication terminals may include DECT telephones or even traditional analog telephones, connectable to a PSTN wall outlet by means of a cord. Another alternative is an IP telephone. The communication terminals may also be radio communication terminals, such as mobile phones operable for communication through a radio base station, or even directly to each other. For the sake of clarity, most embodiments described herein relate to an embodiment in mobile radio telephony, being the best mode of the invention known to date. Furthermore, it should be emphasized that the term comprising or comprises, when used in this description and in the appended claims to indicate included features, elements or steps, is in no way to be interpreted as excluding the presence of other features elements or steps than those expressly stated.

Preferred embodiments will now be described with reference to the accompanying drawings.

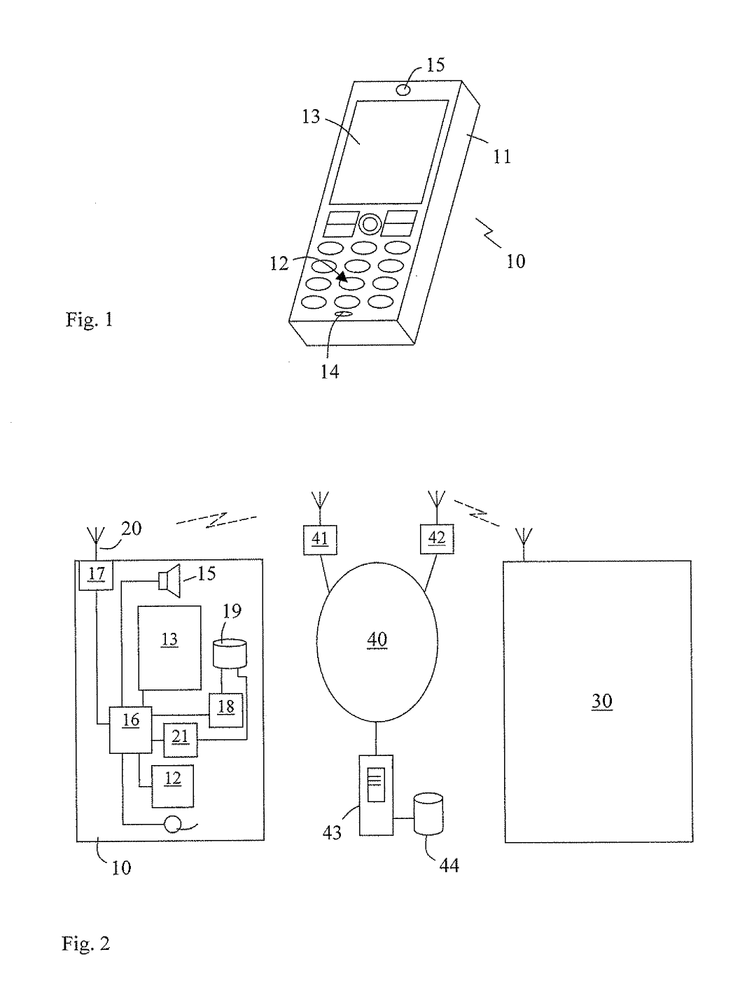

FIG. 1 illustrates an electronic device in the form of a portable communication terminal 10, such as mobile telephone, which may be employed in an embodiment of the invention. Terminal 10 comprises a support structure 11 including a housing, and a user interface operable for input and output purposes. The user interface includes a keypad or keyboard 12 and a display 13. As an alternative solution, display 13 may be touch-sensitive, and serve as an input interface in addition to or instead of keypad 12. Terminal 10 also includes an audio interface comprising a microphone 14 and a speaker 15, usable for performing a speech conversation with a remote party according to the established art. Furthermore, terminal 10 typically includes radio transceiver circuitry, an antenna, a battery, and a microprocessor system including associated software and data memory for radio communication, all carried by support structure 11 and contained within the housing. The specific function and design of the electronic device as a communication terminal is as such of little importance to the invention, and will therefore not be described in any greater detail.

The invention involves speech recognition of a voice conversation using a terminal, and retrieval and presentation of information related to identified keywords of the voice conversation. Different embodiments will be outlined below, where different tasks of the invention are carried out at different places in a voice communication system. For the sake of simplicity, one and the same drawing shown in FIG. 2 will be used for describing the functional relationship between included elements of the different embodiments, even though not all elements of FIG. 2 need to be included in every embodiment. Use cases for specific embodiments are further described with references to separate drawings.

FIG. 2 shows a schematic representation of a system for receiving information, which makes use of speech recognition. The system comprises a first communication terminal 10 and a second communication terminal 30, which are configured to exchange audio signals in a voice conversation. For this purpose, both terminals are equipped with an audio interface as explained with reference to FIG. 1. Terminals 10 and 30 need not be identical, nor do they have to be the same type of communication terminals. As an example, terminal 10 may be a cellular mobile phone while terminal 30 is a standard PSTN phone. For the sake of simplicity, the functional details and process steps carried out will mainly be described for the first terminal 10.

Terminals 10 and 30 may be interconnected by means of wire and an intermediate telephony network, by radio and an intermediate radio communications network, or even directly with each other in certain embodiments. FIG. 2 illustrates an embodiment where both terminals 10 and 30 are mobile phones, communicating over a radio communications network 40, such as a WCDMA network.

The system comprises a speech recognition engine, connected to receive audio signals of a voice conversation carried out between the first 10 and the second 30 communication terminals. The speech recognition engine may be disposed within either terminal 10 or 30, or in the network 40, as will be explained for different embodiments. Furthermore, the speech recognition engine is configured to identify one or more keywords in the audio signal of a voice conversation. An information retrieving unit is communicatively connected to the speech recognition engine, and configured to retrieve information related to an identified keyword, and to present retrieved information to the users of at least one of the first 10 and second 30 communication terminals, by means of the user interface in those terminals.

The particular characteristics of the speech recognition engine are not laid out in detail in this document, since the particular choice of technology is not crucial to the invention. However, it may be noted that one known and usable speech recognition engine or system consist of two main parts: a feature extraction (or front-end) stage and a pattern matching (or back-end) stage. The front-end effectively extracts speech parameters (typically referred to as features) relevant for recognition of a speech signal, i.e. an audio signal representing speech. The back-end receives these features and performs the actual recognition. The task of the feature extraction front-end is to convert a real time speech signal into a parametric representation in such a way that the most important information is extracted from the speech signal. The back-end is typically based on a Hidden Markov Model (HMM), a statistical model that adapts to speech in such a way that the probable words or phonemes are recognized from a set of parameters corresponding to distinct states of speech. The speech features provide these parameters. It is possible to distribute the speech recognition operation so that the front-end and the back-end are separate from each other, for example the front-end may reside in a mobile telephone and the back-end may be elsewhere and connected to a mobile telephone network. Naturally, speech features extracted by a front-end can be used in a device comprising both the front-end and the back-end. The objective is that the extracted feature vectors are robust to distortions caused by background noise, non-ideal equipment used to capture the speech signal and a communications channel if distributed speech recognition is used. Speech recognition of a captured speech signal typically begins with analogue-to-digital-conversion, unless a digital representation of the speech signal is present, pre-emphasis, and segmentation of a time-domain electrical speech signal. Pre-emphasis emphasizes the amplitude of the speech signal at such frequencies in which the amplitude is usually smaller. Segmentation segments the signal into frames, each representing a short time period, usually 20 to 30 milliseconds. The frames are either temporally overlapping or non-overlapping. The speech features are generated using these frames, often in the form of Mel-Frequency Cepstral Coefficients (MFCCs). MFCCs may provide good speech recognition accuracy in situations where there is little or no background noise, but performance drops significantly in the presence of only moderate levels of noise. Several techniques exist to improve the noise robustness of speech recognition front-ends that employ the MFCC approach. So-called cepstral domain parameter normalization (CN) are some of the techniques used for this purpose. Methods falling into this class attempt to normalize the extracted features in such a way that certain desirable statistical properties in the cepstral domain are achieved over the entire input utterance, for example zero mean, or zero mean and unity variance. A system and method for speech recognition is presented in WO 94/22132, which is enclosed herein by reference.

In a first embodiment, a speech recognition engine 18 is included in first terminal 10. As implicitly outlined in the preceding paragraph, speech recognition is a computer process, and a speech recognition engine therefore typically includes computer program code executable in a computer system, such as by a microprocessor of a mobile phone or in a network server. Block 18 of FIG. 2 represents the computer program object for the speech recognition engine, which is functionally connected to a control unit 16 of terminal 10, typically a microprocessor with associated operation system and memory space. Speech recognition engine 18 may also be connected to an associated data memory 19 for storing of information, as will be outlined. The user interface of terminal 10 is also schematically illustrated in FIG. 2, including microphone 14, speaker 15, keypad 12, and display 13. Furthermore, terminal 10 includes a transceiver unit 17, in the illustrated embodiment a radio signal transmitter and receiver connected to an antenna 20. In accordance with the established art, terminal 10 is configured to communicate with a remoter party 30 over network 40, by radio communication between antenna 20 and a base station 41 of network 40. The remote party terminal 30 is further communicatively connected to another base station 42 of network 40, or possibly the same base station.

In one embodiment of the invention, a voice conversation is initiated between a first user of terminal 10 and a second user of terminal 30. While conducting the voice conversation, a situation arises where one or both of the users are interested in obtaining more information about a topic they. The user of terminal 10 may then enter a command in terminal 10, preferably by means of keypad 12, to start passing the audio signal of the voice conversation to the speech recognition engine 18. A second command may also be given to terminate passing of the audio signal to speech recognition engine 18, whereby an audio signal segment confined in time is defined to be subjected to speech recognition. This way a selected number of phrases or keywords may be uttered for speech recognition, in order to guide the speech recognition engine 18 to make the correct identification of keywords, instead of performing speech recognition on the entire conversation. In one embodiment, the audio signal is passed in real time to speech recognition engine 18 after making the command. In an alternative embodiment, terminal 10 comprises an audio recorder 21, controlled by commands given by means of keypad 12 to initiate and terminate recording of the audio signal of the voice conversation and saving a recorded audio signal segment in a memory 19. Speech recognition engine 18 then performs speech recognition on the recorded audio signal to identify keywords.

The keyword or keywords identified by speech recognition engine 18 are then passed to an information search engine. In one embodiment, terminal 10 holds such an information search engine, forming part of the software of control unit 16. The information search engine uses signal transceiver 17 to connect to network 40, and from there preferably to the Internet for collecting information. Alternatively, terminal 10 may have a separate communication link to the Internet, not involving the link through which communication with remote terminal 30 is performed. For instance, terminal 10 may communicate with terminal 30 over a WCDMA network 40, and at the same time have a WLAN connection to the Internet over another frequency band and using another signal transceiver, or even a wire connection to the Internet. The information search engine performs an information search, and retrieves information related to the keywords.

The retrieved information is then presented to the user of terminal 10 or 30, or both. In a preferred embodiment, the information retrieved is presented graphically on display 13, using text, symbols, pictures or video. As an alternative solution, the information may be presented by means of sound, e.g. by using 15 or an additional handsfree speaker of terminal 10. The information may then be read by a synthesized voice, or alternatively the information may be obtained as an audio signal by the information search engine.

Preferably, the steps of performing speech recognition to identify keywords, retrieving information related to the keywords, and presenting the information on one or both of terminals 10 and 30, are performed while conducting the voice conversation. This means that an online service is created which provides additional value to traditional voice calls.

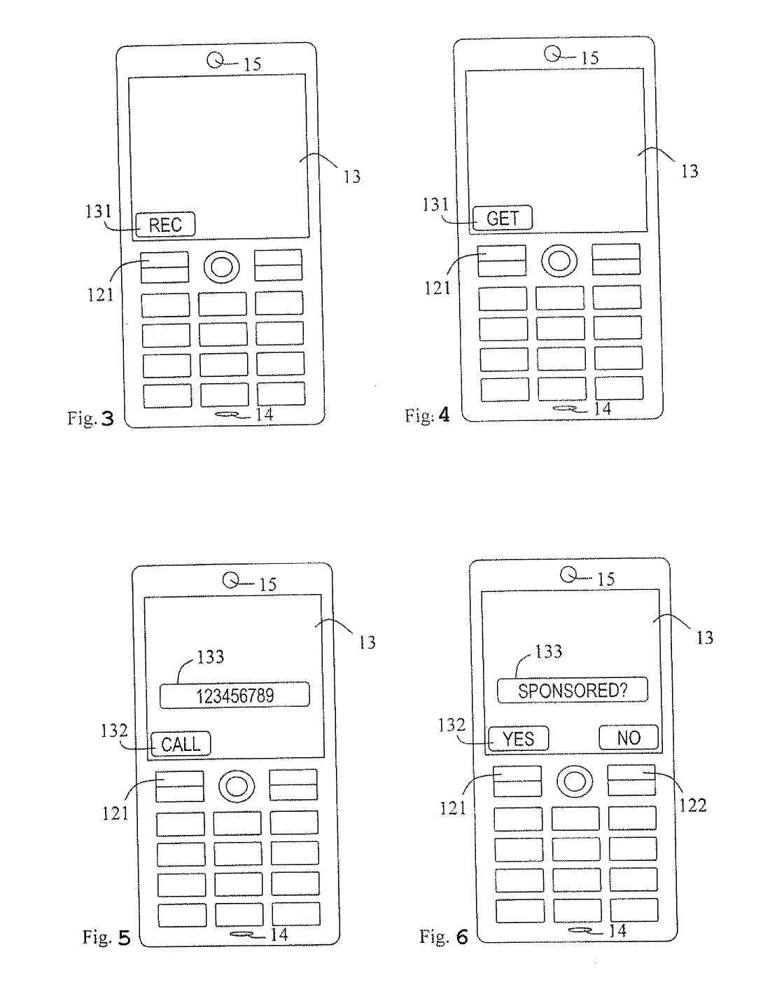

FIGS. 3 and 4 schematically illustrate the use of an embodiment according to the invention, in a terminal 10 which is one of two or more terminals communicating in a voice conversation session. While the voice conversation is ongoing, a softkey label 131 is presented on display 13, linked to adjacent key 121 of keypad 12. Softkey label 131 shows a selectable command “REC”, indicating that pressing of key 121 initiates recording of an audio signal as either entered by means of microphone 14 or as outputted by means of speaker 15, or both. Preferably, the audio signal captured by microphone 14 is recorded upon giving the REC command. In one embodiment, recording continues for a preset time period such as 5 seconds, and then terminates automatically. Alternatively, recording continues until a second command to terminate recording is entered in terminal 10. this may be solved in different ways. One option is to use a double click procedure, whereby label 131 changes to show another command, after initiating recording. FIG. 4 shows such an example, where label 131 has switched to show “GET” after initiation of recording. When key 121 is pressed a second time recording is terminated, where after the speech recognition process and information retrieval preferably starts automatically. An alternative solution is to continue recording as long as key 121 is held down, such that recording is terminated when key 121 is released. Yet another alternative is of course to press another key to terminate recording.

In an embodiment using real time speech recognition, key 121 is instead pressed down to initiate. Label 131 then preferably has another text, such as “INTERPRET”, or simply “GET INFO”, since activation of key 121 starts the process of speech recognition, keyword identification and information retrieval. Termination of the speech recognition process may be performed in a similar manner as outlined above, i.e. by a renewed activation of key 121 or by releasing key 121.

In a scenario for using this embodiment of the invention, a user A uses terminal 10 to initiate a voice call to a terminal 30 of a user B. Users A and B starts to debate whether an alternative name for anemone nemorosa is sunflower or windflower. User A then presses key 121 and says “anemone nemorosa”, whereby the speech signal of user A is captured by microphone 14 and recorded by audio recorder 21 and stored in memory 19. When user A pressed key 121 the first time, label 131 changed to “GET”, and when key 121 is pressed again after uttering the afore-mentioned words the recording is terminated, and speech recognition engine 18 is activated to identify keywords in the recorded signal. In the present case, the input speech signal are keywords as such, and once the speech recognition engine 18 identifies those keywords they are sent to the information search engine. The search engine will then find a botanical information site, typically on the Internet but alternatively in a local memory in terminal 10 or in network 40, from which information related to the input keyword is retrieved. The retrieved information is then presented at least on terminal 10, preferably on display 13. The information may be presented as clear text or with associated pictures, or merely as one or more links to information sources found by the information search engine, which links may be activated to locate further information. In the outlined example, the information retrieved may comprise a link to the botanical information site, and activation of that link using terminal 10 reveals that the alternative name for anemone nemorosa is indeed windflower. This way information has been obtained while conducting the voice conversation using terminal 10, without having to actively use any other means for retrieving information, such as books or a separate computer.

As an alternative to using a built-in speech recognition engine 18, the recorded audio segment may be sent via signal transceiver 17 to a speech recognition engine 18 housed in a network server 43 of network 40. In such a case, keywords identified in the speech recognition engine of network server 43 is sent back to terminal 10, and possibly also to terminal 30, where the information is presented. The information may e.g. be sent using WAP, or as an sms or mms message. Yet another alternative to this embodiment is to employ also a memory for storing a recorded audio signal in network 40.

Another embodiment of the invention making use of the features of the invention relates to a method for providing sponsored calls. This embodiment makes use of the speech recognition engine to identify keywords in a voice conversation between terminals 10 and 30, and provides advertisement information related to the keywords to at least the terminal from which the call was initiated. This way the cost for the call may be partly or completely sponsored by the advertising company. Preferably, the user of terminal 10 has to approve retrieval and presentation of information, i.e. the user has to agree to receive advertisement information. Such an approval may be performed by entering a command in terminal 10, or already when signing a subscription, such that the sponsored call function is set as a default value. Terminal 10 is then used for initiating voice calls as with any other communication terminal. It may also be possible to choose, during an ongoing call initiated through terminal 10, to make use of the sponsored call feature, by entering a command in terminal 10.

In an alternative embodiment, the user of terminal 10 must always choose whether a sponsored call or a normal, not sponsored, call is to be initiated when making a call. Such an embodiment is illustrated in FIGS. 5 and 6. In FIG. 5 the user of terminal 10 has initiated a call by entering a telephone number, either by means of keypad 12 or by fetching the number from a contact list. The telephone number is presented in a frame 133 on display 13. A softkey label 132 related to key 121 shows command “CALL”, and when the CALL command is given by pressing key 121, the user is questioned whether or not a sponsored call is to be initiated. One way of doing this is shown in FIG. 6. When the CALL command has been given, the query shows up in frame 133, or potentially in addition to the entered telephone number. Over key 121 a YES label has appeared, and over another key 122 a NO label has appeared. Pressing the YES softkey 121 initiates a sponsored call, whereas pressing the NO softkey 122 initiates a normal call.

When a sponsored call has been selected, either as a default setting or a selection related to the specific call just initiated, a call setup is made over network 40 such that communication signals of the voice conversation carried out are guided through a network server 43 including a speech recognition engine. In this scenario, speech recognition is typically performed on digital audio signals, and the speech recognition engine therefore does not have perform an analog-to-digital conversion step. Speech recognition engine may be configured to analyze every spoken word in the voice communication, but is preferably matching only configured to identify a limited set of keywords. In one embodiment the subscriber may also be presented with this set of keywords and approve them, e.g. upon signing the subscription, in order to sort out unwanted types of advertisement. The keywords that have been identified by the speech recognition engine are then matched by an information retrieving unit in server 43 with keywords related to advertisement information stored in a data memory 44. If a match is found, the corresponding advertisement is retrieved from memory 44 and sent to terminal 10, and possibly also to terminal 30, for presentation to the user or users.

When an operator providing the subscription used in terminal 10 registers that a sponsored call has been selected, the advertising company will typically be charged with all or parts of the cost for the call, instead of the subscriber paying the full cost for the call. Alternatively, the operator stands for the call cost, and the advertising company is charged in accordance with the number of ads sent to communication terminals. furthermore, as an alternative to actually lowering the call cost for the user, the user of terminal 10 may instead benefit from a personal offer such as a discount on a product or service provided by the advertising company.

In a scenario for using this embodiment of the invention, a user A uses terminal 10 to initiate a voice call to a terminal 30 of a user B. Upon entering the phone number for terminal 30 and pressing twice key 121 according to FIGS. 5 and 6, a sponsored call is initiated. During the voice conversation carried out between users A and B, audio signals passing through network server 43 are analyzed by the speech recognition engine. When the conversation includes mentioning of Sony Ericsson, this is identified as a keyword in the speech recognition engine, and this keyword is found to be one of a plurality of predetermined keyword related to advertisement information stored in memory 44. An advertisement information object related to the keyword is then retrieved from memory 44 or by connection to another node in network 40, and sent to terminal 10. User A will notice this by seeing that a browser window suddenly pops up on display 13, with an advertisement related to the matched keyword, in this case Sony Ericsson. The advertisement may also include sound, e.g. played by a second speaker on terminal 10. The advertisement as such does not have to be provided by that company, it may for instance instead be an advertisement from the operator, with a special offer involving a subsidized Sony Ericsson mobile phone. The offer as such may be the only benefit obtained by the user, alternatively the call as such may also be partly or fully discounted. Furthermore, the advertisement may be sent only to terminal 10, or also to terminal 30.

Preferred embodiments of the invention have been described in detail, but it should be understood that variations may be made by those skilled in the art. The invention should therefore not be construed as limited to the examples laid out in the description and drawings.

I claim:

1. A method for receiving information in a communication terminal, comprising the steps of:
initiating a voice conversation between a first communication terminal and a second communication terminal;
passing an audio signal of the voice conversation to a speech recognition engine to identify a keyword from the voice conversation;
retrieving information related to the keyword;
presenting the retrieved information in at least one of the first and second communication terminals.

2. The method of claim 1, wherein the voice conversation is carried out over a communications network.

3. The method of claim 2, wherein the speech recognition engine is located in a network server of the communications network.

4. The method of claim 3, wherein an audio signal sent from the first communication terminal to the second communication terminal, or vice versa, is passed through the speech recognition engine.

5. The method of claim 1, comprising the steps of:
entering a command in at least one of the first and second communication terminals to approve retrieval and/or presentation of information, thereby
controlling communication signals of the voice conversation to be guided through a network server including the speech recognition engine.

6. The method of claim 5, wherein the step of entering a command to approve retrieval and/or presentation of information is carried out prior to initiating the voice conversation, as a default setting.

7. The method of claim 5, wherein the step of entering a command to approve presentation of information is carried out during the step of initiating the voice conversation.

8. The method of claim 1, comprising the steps of:
entering a command in at least one of the first and second communication terminals during the voice conversation to initiate passing of the audio signal to the speech recognition engine.

9. The method of claim 1, comprising the steps of:
entering a command in at least one of the first and second communication terminals during the voice conversation to record an audio signal of the voice conversation in a data memory;
entering a command to terminate recording of the audio signal;
passing the recorded audio signal to the speech recognition engine.

10. The method of claim 1, wherein the speech recognition engine is located in one of the first and second communications terminals.

11. The method of claim 9, wherein the data memory is located in one of the first and second communications terminals.

12. The method of claim 1, wherein the step of retrieving information related to the keyword comprises the step of:
entering the keyword in an information search engine.

13. The method of claim 1, wherein the step of retrieving information related to the keyword comprises the step of:
searching the Internet for information related to the entered keyword.

14. The method of claim 1, wherein the step of retrieving information related to the keyword comprises the step of:
matching the keyword with predetermined keywords related to advertisement information stored in a memory, to retrieve an advertisement related to the identified keyword.

15. The method of claim 1, wherein the step of presenting the retrieved information is carried out during the initiated voice conversation.

16. The method of claim 1, wherein the step of presenting the retrieved information involves the step of
presenting an image on a display of at least one of the first or the second communication terminal.

17. The method of claim 1, wherein the step of presenting the retrieved information involves the step of
presenting, on a display of at least one of the first or the second communication terminal, a link to an information source containing more data related to the keyword.

18. The method of claim 1, wherein the step of presenting the retrieved information involves the step of
sounding an audible message by means of a speaker in at least one of the first or the second communication terminal.

19. The method of claim 1, wherein the communication terminals are mobile phones, exchanging audio signals of the voice conversation over a radio communications network.

20. System for receiving information, comprising:
a first communication terminal and a second communication terminal, which are configured to exchange audio signals in a voice conversation;
a speech recognition engine connected to receive an audio signal of a voice conversation carried out between the first and second communication terminals, and to identify a keyword in the audio signal;
an information retrieving unit configured retrieve information related to an identified keyword;
a user interface configured to present retrieved information in at least one of the first and second communication terminals.

21. The system of claim 20, comprising:
a communications network for communicating audio signals between the first and second communication terminals during a voice conversation.

22. The system of claim 21, wherein the speech recognition engine is located in a network server of the communications network.

23. The system of claim 22, wherein an audio signal sent from the first communication terminal to the second communication terminal, or vice versa, is passed through the speech recognition engine.

24. The system of claim 20, wherein at least one of the first and second communication terminals comprises
a user interface for entering a command to approve retrieval and/or presentation of information;
a control unit configured to control audio signals of the voice conversation to be guided through a network server including the speech recognition engine, responsive to entering an approval command.

25. The system of claim 24, wherein the user interface of at least one of the communication terminals comprises
a call initiation function, which can be selectively activated to initiate a voice conversation communication with or without approval to retrieval and/or presentation of information.

26. The system of claim 20, wherein a user interface of at least one of the communication terminals comprises
a speech recognition initiation function, which can be selectively activated during a voice conversation to initiate passing of an audio signal to the speech recognition engine.

27. The system of claim 20, comprising:
a data memory, and
an audio recorder, wherein the user interface of at least one of the communication terminals is operable for entering
a first command for selectively initiate recording of an audio signal of a voice conversation in the data memory;
a second command for selectively terminating recording of the audio signal, and wherein the speech recognition engine is connected to the data memory for performing speech recognition on the recorded audio signal.

28. The system of claim 20, wherein the speech recognition engine is located in one of the first and second communications terminals.

29. The system of claim 27, wherein the data memory is located in one of the first and second communications terminals.

30. The system of claim 20, wherein the information retrieving unit comprises an information search engine.

31. The system of claim 20, wherein the information retrieving unit is communicatively connectable to the Internet for retrieving information related to an entered keyword.

32. The system of claim 20, wherein the information retrieving unit is configured to match an identified keyword with predetermined keywords related to advertisement information stored in a memory, to retrieve an advertisement related to the identified keyword.

33. The system of claim 20, wherein the user interface comprises a display for presenting retrieved information.

34. The system of claim 20, wherein the user interface comprises a speaker for presenting retrieved information.
